(19) United States
(12) Patent Application Publication
(10) Pub. No.: US 2015/0260948 A1
(43) Pub. Date: Sep. 17, 2015

(54) LENS DRIVING DEVICE, CAMERA DEVICE, AND ELECTRONIC APPARATUS

(71) Applicant: New Shicoh Technology Co., Ltd., Kanagawa (JP)

(72) Inventors: Kazuya Yamakage, Kanagawa (JP); Yosuke Chiyohara, Kanagawa (JP); Kei Onodera, Kanagawa (JP)

(21) Appl. No.: 14/636,620

(22) Filed: Mar. 3, 2015

(30) Foreign Application Priority Data
Mar. 14, 2014 (JP) 2014-051562

(51) Int. Cl. G02B 7/09; G03B 3/10

(52) U.S. Cl. CPC G02B 7/09; G03B 3/10

(57) ABSTRACT

A lens driving device, a camera device, and an electronic apparatus which are able to be miniaturized are provided. A lens driving device includes: a lens holder for holding a lens; a coil mounted on the lens holder; spring members which movably support the lens holder and are electrically connected to the coil; a supporter for supporting the spring members; wherein the supporter has at least two joining members located apart from each other to which the spring members are joined, at least one of the at least two joining members is used as a terminal for being electrically connected to an external circuit and other at least one joining member is used as a dummy terminal which is not electrically connected to the external circuit.

### CROSS-REFERENCE TO RELATED APPLICATIONS

The present application claims the benefit of Japanese Patent Application No. 2014-051562 filed on Mar. 14, 2014, which is incorporated herein by reference in its entirety.

### TECHNICAL FIELD

This invention relates to a lens driving device, a camera device, and an electronic apparatus.

### BACKGROUND ART

Electronic apparatuses such as cellular phones and smart phones are equipped with a miniaturized camera. The miniaturized camera of this type is an automatic focusing type. The miniaturized camera of this automatic focusing type includes a lens driving device for actuating the lens to move.

Japanese Patent Application Laid-Open Publication No, JP2011-22366 A discloses a lens driving device featuring that an approximately cylindrical carrier around of which a first coil/magnet is provided is supported by an upper spring member at its upper portion and a lower spring members at its lower portion; the upper and the lower spring members are supported by an upper and a lower spring supporting members, respectively; and an intermediate member positioned between the upper and the tower spring supporting members is provided with a second magnets/coil at its inner surface corresponding to the first coil/magnet so as to move the carrier into upward and downward direction by the electromagnetic force generated by electric current through the coil; Wherein the lower spring supporting member is integrally formed with lead frames made of metal sheet; the lead frames include frame parts includes first fixing parts for fixing the lower spring member; and second fixing parts formed on the lower spring members are welded to the first fixing parts of the lead frames.

Japanese Patent Application Laid-Open Publication No. JP2012-247654 A discloses a lens driving device including: a lens holder for holding a lens; leaf spring members supporting the lens holder in a direction of the optical axis of the lens; and a base member for fixing the leaf spring members, and having external terminals for being electrically conducted to the leaf spring; wherein the leaf spring members are formed with joining tabs extending toward the external terminals, each joining tabs has: a fixing part for fixing the joining tabs onto the base member at the proximal end thereof; a joining member for being joined to the external terminal; and a pressing part, for being pressed toward the base me0mber at its distal end thereof opposing across the pressing part.

### SUMMARY

In the lens driving devices of the above, the lead frames made of metal cover the almost entire surface of lower spring supporting member; or includes the fixing part for fixing the leaf spring members onto the base member and. the joining member for electrically connecting the leaf spring members to the external terminal, thus these configurations hinder miniaturization of the lens driving device.

This invention aims to provide a lens driving device, a camera device, and an electronic apparatus which are able to be miniaturized.

A lens driving device according to one aspect of the invention includes: a lens holder for holding a lens; a coil mounted on the lens holder; spring members which movably support the lens holder and are electrically connected to the coil; a supporter for supporting the spring members; wherein the supporter has at least two joining members located apart from each other to which the spring members are joined, at least one of the at least two joining members is used as a terminal for being electrically connected to an external circuit and other at least one joining member is used as a dummy terminal which is not electrically connected to the external circuit.

Preferably, the joining members are integrally formed with the supporter.

Preferably, the supporter is formed as a rectangular shape in outline and the joining member being the terminal is formed at a first corner of the supporter while the other joining member being the dummy terminal is formed at a second corner of the supporter adjacent to the first corner; the spring members has a body portion extending from the first corner of the supporter to the second corner, the body portion has a parts to be joined at both ends, the parts to be joined are connected to the joining member being the terminal and the joining member being the dummy terminal.

Preferably, the body portion of the spring member has a first positioning part located between the parts to be joined, the first positioning part is engaged with a second positioning part formed at the supporter.

Preferably, the at least two joining members are formed at locations apart from the peripheral side face of the supporter.

According to another aspect of the present invention, a camera device includes: a lens driving device of the above aspect of the invention; a lens held by the lens holder; and an image sensor being provided about the optical axis of the lens.

According to other aspect of the present invention, an electronic apparatus is equipped with the camera device of the above aspect of the invention.

According to the present invention, the spring members are joined to the at least two joining members which are formed with the supporter for the spring members and are positioned apart from each other, at least one of the at least two joining members is the terminal for being electrically connected to the external circuit and other at least one joining member is the dummy terminal which is not electrically connected to the external circuit, thus the lens driving device can be miniaturized.

### BRIEF DESCRIPTION OF THE DRAWINGS

FIG. 1 is an exploded perspective view of the lens driving device according to one embodiment of the present invention.

FIG. 2 is a cross-sectional view of the lens driving device according to one embodiment of the present invention.

FIG. 3 is a plan view showing a supporter for spring members used in the lens driving device according to one embodiment of the present invention.

FIG. 4 is a plan view of a lead frame formed with the supporter for spring members during the process for forming the supporter for spring members used in the lens driving device according to one embodiment of the present invention.

FIG. 5 is a plan view of lower spring, members and the supporter for spring members, being assembled together, used in the lens driving device according to one embodiment of the present invention,

FIG. 6 is an enlarged plan view of a positioning parts of the lower spring member used in the lens driving device according to one embodiment of the present invention.

### DETAILED DESCRIPTION OF PREFERRED EMBODIMENT OF THE INVENTION

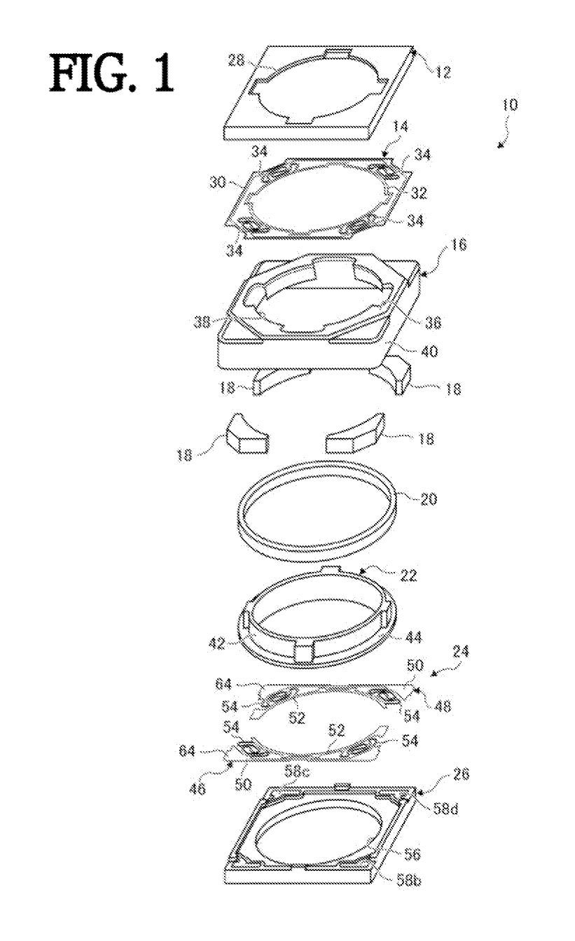

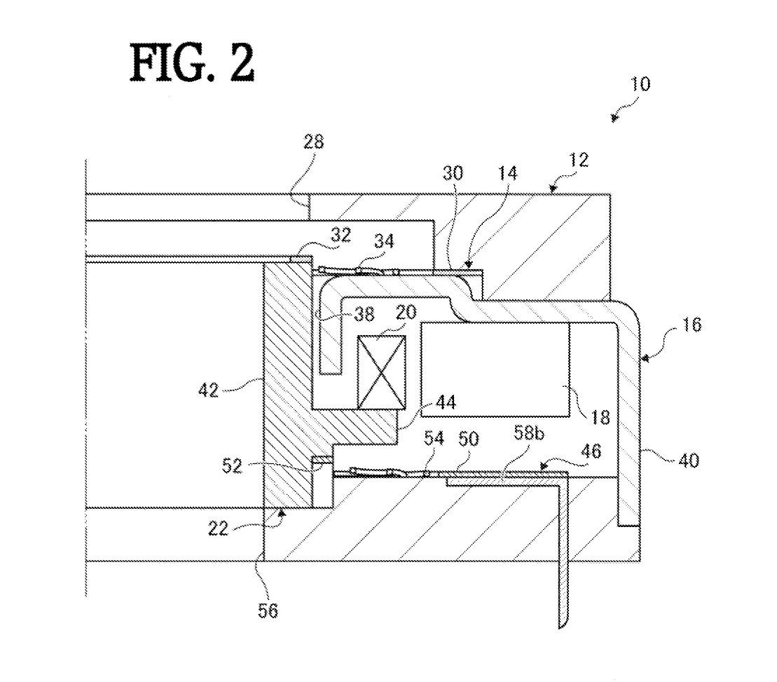

One embodiment of the present invention is described with reference to the drawings. A lens driving device 10 shown in FIGS. 1 and 2 is used for a miniaturized camera of an automatic focusing type which is installed in an electronic apparatus such as a cellular phone and a smart phone. The lens driving device 10 includes: a frame 12, an upper spring member 14, a yoke 16, magnets 18, a coil 20, a lens holder 22, lower spring members 24, and a supporter 26 for spring members 24. It would be noted throughout this explanation that one direction along the optical axis of the lens driving device 10 is referred to as upward direction, for convenience of explanation, while the opposite direction is referred to as downward direction.

The frame 12 is formed in a rectangular shape viewing from the above, and is also has a circular first through-hole 28, through which the light passes.

The upper spring member 1.4 includes an upper spring body portion 30 formed so as to surround the upper spring, member 14 itself at its outer circumference, an upper support portion 32 formed in a circular shape, and connecting portions 34 which connect the upper spring body portion 30 and the upper support portion 32. The connecting portions 34 are elastically deformable, especially in upward and downward directions. In the present embodiment four connecting portions 34 are formed apart from each other with a predetermined interval and support the upper support portion 32 in a movable manner against the upper spring body portion 30.

The yoke 16 is formed in a rectangular shape viewing from the above. The yoke 16 has a seat 36 for installing the upper spring member 14 at its upper surface. The yoke 16 has a circular second through-hole 38 inside the seat 36 through which second though-hole 38 the light passes. The yoke 16 has side walls 40 formed downwardly extended from each four sides of the yoke 16. The upper spring member 14 is supported by its upper spring body portion 30 being fixed between the under surface of the frame 12 and the seat 36 of the yoke 16.

The magnets 18 include, for example, four magnetic pieces. Each magnetic piece has two outer planer side surfaces which are orthogonal to each other and an arc-shaped inner surface. The side surfaces are fixed inside of the side walls 40 of the yoke 16 at its each four corners.

The coil 20 is formed as a circular-ring shape. The coil 20 is formed by winding a core wire made of metal such us copper. The outer peripheral surface of the coil 20 faces against the inner surfaces of the magnet pieces 18.

The lens holder 22 has a cylindrical holder body 42 and a coil fixing part 44 formed in a flanged shape outwardly extended at the lower most end of the cylindrical holder body 42. The holder body 42 is formed with threads at its inner surface so that the lens (not shown) can be screwed to be fastened on the inside of the holder body 42. The coil 20 is fixed onto the coil fixing part 44. The upper most end of the lens holder 22 is attached and fixed to the upper support portion 32 of the upper spring member 14.

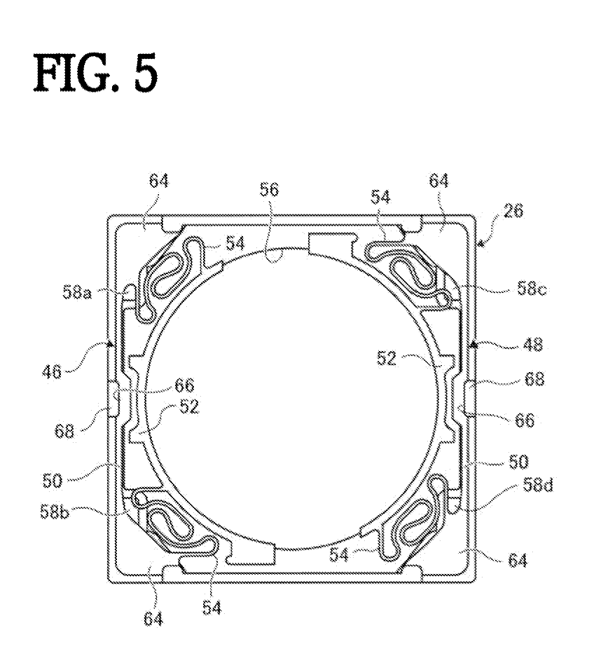

As shown in FIG. 5, the lower spring: member 24 includes two members: a first lower spring member 46 and a second lower spring member 48. The first lower spring member 46 and the second lower spring member 48 each has a lower spring body portion 50 formed in an approximately linear shape, a lower support portion 52 formed in an arch-shape, and connecting portions 54 connecting the lower spring body portion 50 and the lower support portion 52. The connecting portions 54 are elastically deformable especially in the upward-downward direction, in which two connecting portions 54 are formed with a predetermined distance for the each first and second lower spring members 46, 48, and movably support the lower support portion 52 against the lower spring body portion 50.

The lower most end of the lens holder 22 is attached and fixed to the lower support portions 52 of the first lower spring member 46 and the second lower spring member 48. In this embodiment, the lower spring members 24, in combination with the upper spring member 14, perform functions to bias the lens holder 22 downwardly and to restore the position of the lens holder 22 back to the original position when the electric current does not flow through the coil 20. The lower support portion 52 of the first lower spring member 46 is electrically connected with one end of the core wire of the coil 20 while the lower support portion 52 of the second spring member 48 is electrically connected with the other end of the core wire of the coil 20.

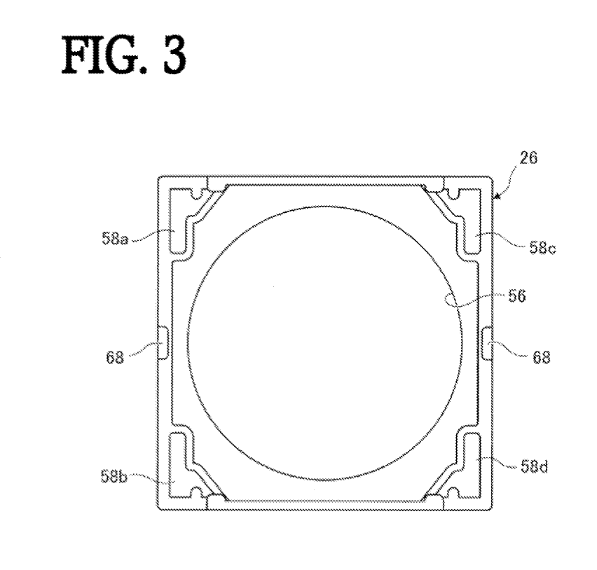

The supporter 26 for the spring members, as shown in FIG. 3, is also a base for the lens driving device 10; and is formed in a rectangular shape viewing from the above. The supporter 26 has a circular third through-hole 56 through which third through-hole 56 the light passes. The supporter 26 is provided with joining members 58a-58d located apart from each other on the upper surface at the inside of the each four corners of the supporter 26. The joining members 58a-58d are formed as a planar shape and are located slightly inside from the outer peripheral sides of the supporter 26. The joining members 58a-58d are of “h” shape. The longest line part of this “h” shape is used for joining the joining members 58a-58d with the lower spring members 24. One of the two lower ends of this “h” shape is folded in almost the right angle while the other end is continued to a connecting piece 62 as mentioned below. The heights of the joining members 58a-58d are approximately the same height with the supporter 26 surrounding the joining members 58a-58d in order that the joining members 58a-58d and the lower spring members 24 are contacted in a stable fashion when the lower spring members 23 are installed onto the supporter 26 and the joining members 58a-58d. As show in FIG. 1, two joining members 58a, 58b among the joining members 58a-58d are joined with the first lower spring member 46 while the other two joining members 58c, 58d are joined with the second lower spring member 48. Two joining members e.g. 58b, 58d, among the joining members 58a-58d, which are disposed on the lower side of the FIG. 3 are used as terminals for being electrically connected with an external circuit and are folded in almost the right angle at the ends of the “h” shape to extend and protrude downwardly from the under surface of the supporter 26, However, the other two joining members e.g. 58a, 58c which are disposed on the upper side of the FIG. 3 are dummy terminals which do not electrically connected to external circuits. The joining members 58a, 58c are folded in almost the right angle at the ends of the “h” shape but do not extend and protrude from the under surface of the supporter 26. One or two or more terminals and dummy terminals can be used with the supporter 26. Since the joining members 58a-58d are not located on the center regions of each side of the supporter 26, the distance between the outside edge of the supporter 26 and the third through-hole 56 can be minimized, thus the lens driving device 10 can be miniaturized. Further, since the lower spring members 46, 48 are fixed to the supporter 26 at plurality of remote locations apart from each other, thus the each lower spring members 46, 48 can be firmly fixed onto the supporter 26.

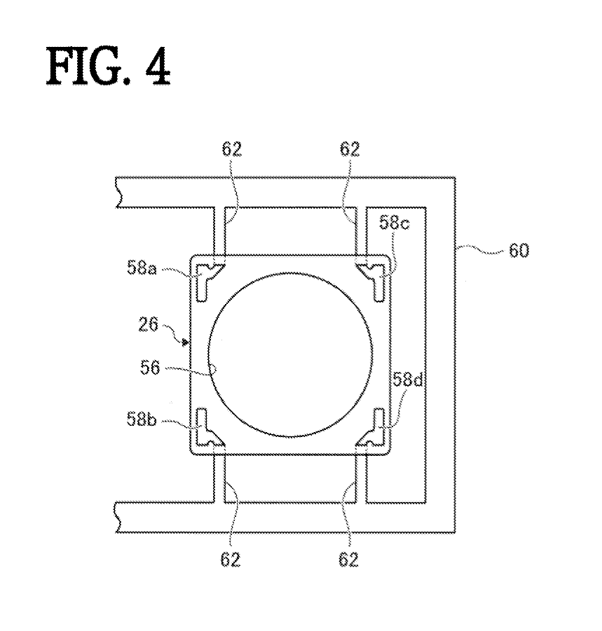

The joining members 58a-58d are integrally formed, using insert molding for example, with the supporter 26. During the process of insert molding, as shown in FIG. 4, a lead frame 60 to which the joining members 58a-58d are already formed is placed in a mold inside of which corresponds to the outline of the supporter 26, and resin is injected to the mold. Thereafter, the connecting pieces 62 of the lead frame 60 are cut apart at the outside edge of the supporter 26, thus each supporter 26 is formed. The joining members 58a-58d are provided at locations apart from the outside edge of the supporter 26, thus the flow of resin can be enhanced and the strength also can be ensured.

Each lower spring body portions 50 of the first lower spring member 46 and the second lower spring member 48 is formed with a part 64 to be joined in which the end of the lower spring body portion 50 expands toward inside of the supporter 26. The parts 64 of the lower spring body portions 50 are overlapped with the joining members 58a-58d and are welded together by a laser beam, for example. One of the lower spring body portions 50 is joined to the joining member 58a which is the dummy terminal and the joining member 58b which is the neighboring terminal of the joining member 58a, while the other lower spring body portion 50 is joined to the joining member 58c Which is the dummy terminal and the joining member 58d which is the neighboring terminal of the joining member 58c. The parts 64 to be joined and the joining member 58a-58d are joined together by not only using laser welding but also using soldering, or using conductive adhesive.

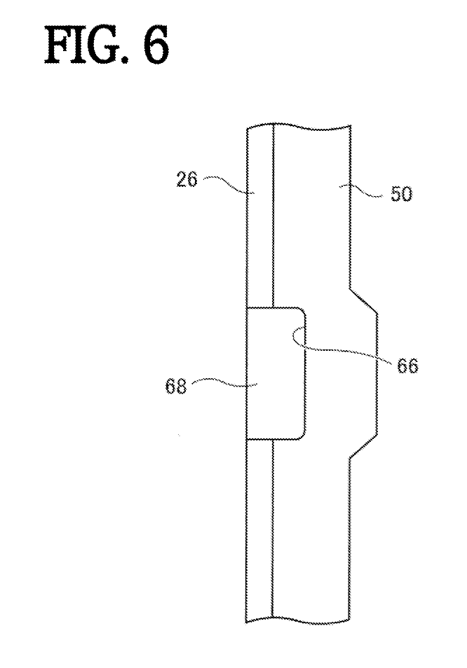

The lower spring body portion 50 is linearly formed at slightly inside along the outer peripheral side of the supporter 26 so as to connect the joining members 58a with 58b, and 58c with 58d, thus the positioning accuracy can be enhanced. Further, as shown in FIG. 6, each of the lower spring body portions 50 is formed with a first positioning part 66 at the region between the joining members. The first positioning part 66 is engaged with a second positioning part 68 which is formed slightly and upwardly protruded from the supporter 26 itself, thus the lower spring bodies 50 are positioned to the supporter 26 with a high accuracy. In this embodiment, the first positioning part 66 of the lower spring body portion 50 is formed to be concave toward the inside while the second positioning part 68 is formed to be convex toward the inside. However, the invention is not limited to the above examples but also can be applied to where the first positioning part 66 of the lower spring body portion 50 is a convex shape while the second positioning part 68 of the supporter is concave shape. Further, in this embodiment, the lower spring members 24 are of two independent members such as the first lower spring member 46 and the second lower spring members 48. However, it is not necessary to divide the lower spring members 24 into two pieces. Also, the lower spring members 24 may be divided into three or more pieces.

A lens is held by the lens holder 22. A lens driving device 10 in which the lens holder 22 bolding the lens is installed in a camera device. in the camera device, light input from an imaging target through the lens is detected by an imaging sensor. A controller being provided in the camera device calculates a movement amount of the lens for focusing on the imaging target. The controller controls the voltage to be applied to the joining members 58b, 58d which are the terminals so that the voltage corresponds to the movement amount of the lens. When the voltage is applied to the joining members 58b, 58d, electric current flows from one joining member 58b through the first lower spring member 46, the coil 20, and the second lower spring member 48 to the other joining member 58d. When electric current flows through the coil 20, a magnetic flux is generated between the magnet 18 and the coil 20, and an upward force is applied to the coil 20. When the fame is applied to the coil 20, the lens together with the coil 20 and the lens holder 22 moves against the spring force of the upper spring member 14 and the lower spring. members 24, thus the lens is focused on the imaging target.

The camera device mentioned above is used for electronic apparatus such as cellular phones and smart phones.

1. A lens driving device comprising:
a lens holder for holding a lens;
a coil mounted on the lens holder;
spring members that movably support the lens holder and are electrically connected to the coil;
a supporter for supporting the spring members; wherein
the supporter has at least two joining members located apart from each other to which the spring members are joined, at least one of the at least two joining members is used as a terminal for being electrically connected to an external circuit and other at least one joining member is used as a dummy terminal which is not electrically connected to the external circuit.

2. The lens driving device according to claim 1, wherein the joining members are integrally formed with the supporter.

3. The lens driving device according to claim 1, wherein the supporter is formed as a rectangular shape in outline and the jarring member being the terminal is formed at a first corner of the supporter while the other joining member being the dummy terminal is formed at a second corner of the supporter adjacent to the first comer;
the spring member has a body portion extending from the first corner of the supporter to the second corner, the body portion has puts to be joined at both ends, the parts to be joined are connected to the joining member being the terminal and the joining member being the dummy terminal.

4. The lens driving device according to claim 3. Wherein the body portion of the spring member has a first positioning part located between the parts to be joined, the first positioning part is engaged with a second positioning part formed at the supporter.

5. The lens driving device according to claim 1, wherein the at least two joining members are formed at locations apart from the peripheral side face of the supporter.

6. A camera device comprising:
a lens driving device;
a lens held by a lens holder; and
an image sensor being provided about the optical axis of the lens; wherein
the lens driving device includes:
the lens holder for holding a lens;
a coil mounted on the lens holder;
spring members that movably support the lens holder and are electrically connected to the coil;
a supporter for supporting the spring members; wherein
the supporter has at least two joining members located apart from each other to which the spring members are joined, at least one of the at least two joining members is used as a terminal for being electrically connected to an external circuit and other at least one joining member is used as a dummy terminal which is not electrically connected to the external circuit.

7. An electronic apparatus being equipped with the camera device, the camera device including:
a lens driving device;
a lens held by a lens holder; and
an image sensor being provided about the optical axis of the lens; wherein
the lens driving device includes:
the lens holder for holding a lens;
a coil mounted on the lens holder,
spring members that movably support the lens holder and are electrically connected to the coil;
a supporter for supporting the spring members; wherein
the supporter has at least two joining members located apart from each other to which the spring members are joined, at least one of the at least two joining members is used as a terminal for being electrically connected to an external circuit and other at least one joining member is used as a dummy terminal which is not electrically connected to the external circuit.
